(19) United States
(12) Patent Application Publication
(10) Pub. No.: US 2006/0289085 A1
(43) Pub. Date: Dec. 28, 2006

(54) Guide device for cutting elongate workpieces

(76) Inventor: Denis Leonard Betts, Badgers Mount (GB)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/455,117

(22) Filed: Jun. 16, 2006

(30) Foreign Application Priority Data
Jun. 23, 2005 (GB) 0512831.9

(51) Int. Cl. B27C 5/00

(52) U.S. Cl. 144/144.1

(57) ABSTRACT

A device for cutting elongate workpieces such as a skirting comprises a sleeve of galvanised steel or the like shaped and dimensioned to fit over the workpiece and to be secured at any desired position along the length of the workpiece by fixing means such as a screw. The device comprises a pair of opposed templates with guide slots such as for cutting the workpiece to a desired length, shaping its ends. By positioning a workpiece between and passing a saw or other cutting tool between selected opposed guide slots, the device can be used for making joints in various configurations, by cutting workpieces at different angles.

### BACKGROUND OF THE INVENTION

1. Field of the Invention

This invention relates to a guide device for cutting and shaping elongate workpieces, particularly wooden workpieces such as skirting boards.

2. Description of the Prior Art

Templates for cutting square or mitre joints are disclosed for example in German Patent 19909423 of Strauss. A similar device for cutting cove bases is disclosed in Stoller U.S. Pat. No. 5,522,296.

Cutting large elongate workpieces such as skirting boards accurately to the correct length on site can be difficult in the absence of means for holding the workpiece in position relative to the cutting device such as a saw. Skirting boards for example have to have their ends cut at particular angles, typically 45°, to enable them to form neat mitre joints in the corners of the room.

### SUMMARY OF THE INVENTION

It is an object of the present invention to provide a device which can be secured to an elongate workpiece and guide a saw or other cutting tool so that the workpiece can be cut to the correct angle in a single operation.

The present invention provides a guide device for cutting elongate workpieces, comprising a pair of templates spaced apart in fixed positions relative to one another, with a passage to enable an elongate workpiece to pass through the device, the templates being connected together above and below the passage, wherein at least one guide slot is provided in each template, at least one said guide slot in one template being offset relative to a guide slot in the other template whereby a cutting tool passing through both said guide slots will be held at a fixed angle relative to a workpiece extending through the passage. Clamping means are preferably provided for securing a workpiece extending between a pair of said guide slots.

The templates are preferably of elongate rectangular shape, and held in a spaced relationship parallel to one another. Preferably fixedly secured at both ends by struts or webs extending between them. In one preferred embodiment, the templates are spaced by webs which themselves include one or more slots extending between respective pairs of guide slots in the templates. The webs preferably have edge flanges by which they are secured to the respective templates for example by welding or soldering.

The template is preferably made of metal, more preferably galvanised steel, making it suitably robust for both indoor and outdoor use. It can be made from sheet steel or other material such as aluminium, or indeed non metals such as glass fibre reinforced plastics. In the latter case, the whole device can be moulded.

### BRIEF DESCRIPTION OF THE DRAWINGS

Further objects and advantages of the invention will become apparent from the following detailed description when read with reference to the accompanying drawings which illustrates a preferred embodiment thereof.

In the drawings:

FIG. 1 shows a perspective view of a device according to a second embodiment of the invention; and

FIG. 2 is a horizontal cross section on the line II-II of FIG. 1.

### DETAILED DESCRIPTION OF THE PREFERRED EMBODIMENTS

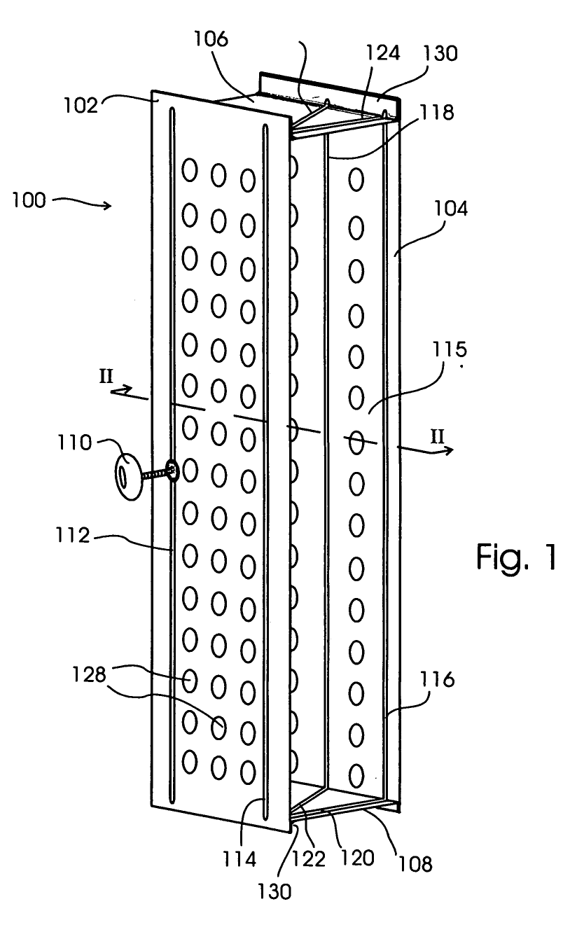

Referring now to FIG. 1, a guide device in the form of a sleeve generally indicated by 100 is in the form of a sleeve with a central passage 115 to allow the passage between two opposed parallel templates 102, 104 of an elongate workpiece such as a plank to be cut at a desired angle, for example to form mitre joints.

The parallel templates 102, 104 are secured spaced a fixed distance from one another by transverse webs 106, 108, suitably by welding, for which purpose the webs are bent to form edge flanges 130 abutting the ends of the templates.

To secure a workpiece in position, a screw 110 is provided in a slot 112 and can be moved vertically to any desired position. Instead of having the screw mounted in such a slot, screws could be mounted in individual threaded bores. More than one such screw can be provided if necessary, in order to secure a workpiece against any longitudinal, lateral or twisting movement.

The template 102 is provided with a guide slot 114, and template 104 is provided with guide slot 116, 118. Guide slots 114 and 116 are positioned opposite one another so that a cut can be made perpendicular to the longitudinal direction of a workpiece. The guide slot 118 is offset relative to guide slot 114 so that a saw passing between the two will be at a 45° angle relative to the templates and to a workpiece clamped between them. A precise and accurate 45° mitre joint can thus be cut and formed.

Slots in the webs 106, 108 connect the guide slots of the two templates, so that a saw can pass right through a workpiece resting on one of the webs, without grating against the web. Thus, guide slots 120, 124 connect guide slots 114 and 116 and the offset guide slots 114, 118 are connected by slots 122, 126 in the respective webs 108, 106.

The device of FIG. 1 can for example be made of galvanised steel or aluminium. To reduce weight, holes such as 128 can be drilled through each of the templates, without significantly weakening the templates. The welds between templates and webs create a rigid structure in which the alignment of the guide slots is maintained at the precise required angles and spacings.

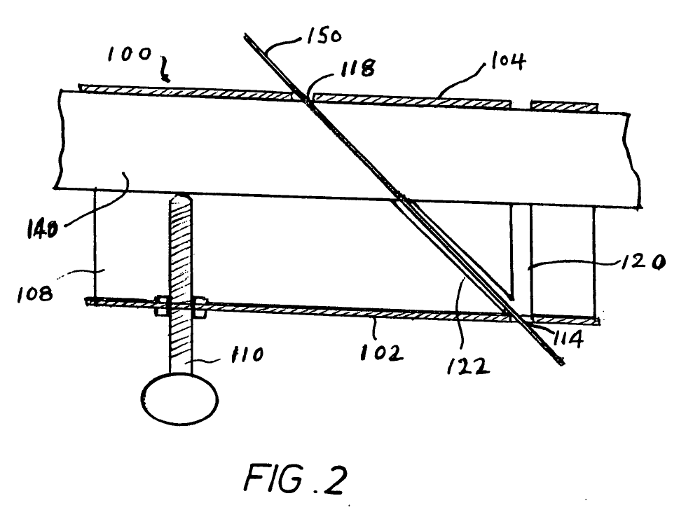

In FIG. 3, a plank 140 is shown clamped in position in the device 100 of FIG. 2 by the screw clamp 110, which holds the plank firmly against the template 104, a bottom edge of the plank resting on web 108. A saw blade 150 or the like is passed through guide slots 114, 118, and thus held at a precise 45° angle across the workpiece. The plank can thus be cut through at 45° the whole way until the saw blade reaches the slot 122 in web 108. Each half of the plank can then be used to form a 45° mitre joint.

What is claimed is:

1. A guide device for cutting elongate workpieces, comprising a pair of templates in the form of elongate flat plates spaced apart in fixed positions relative to one another to define between them a passage to enable an elongate workpiece to pass through the device, the templates being connected together at opposed ends thereof by webs above and below the passage, wherein at least one elongate guide slot is provided in each template, at least one said guide slot in one template being offset relative to a guide slot in the other template, whereby a cutting tool passing through both said guide slots will be held at a fixed angle relative to a workpiece passing through the aperture.

2. A guide device according to claim 1 wherein clamping means are provided for securing a workpiece extending between a pair of said guide slots.

3. A guide device according to claim 2 wherein said clamping means comprises a screw threadedly mounted in one of said templates, to urge a workpiece against the opposite template.

4. A guide device according to claim 3 wherein said screw is mounted in a slot in one said template, so as to be movable between different positions for securing a workpiece.

5. A device according to claim 1 having a plurality of pairs of said guide slots aligned at different angles, one guide slot of each pair being provided in each template.

6. A device according to claim 1 wherein the elongate guide slots extend between said webs, in a direction parallel to the longitudinal direction of the templates.

7. A device according to claim 1 wherein guide slots are provided in said webs, extending between the ends of respective guide slots in the opposed templates.

8. A device according to claim 1 wherein the templates are made of sheet metal.
